(19) United States
(12) Patent Application Publication
(10) Pub. No.: US 2013/0107504 A1
(43) Pub. Date: May 2, 2013

(54) WATERPROOF TORCH

(71) Applicant: Rainer Opolka, Solingen (DE)

(72) Inventor: Rainer Opolka, Solingen (DE)

(21) Appl. No.: 13/704,494

(22) PCT Filed: Jun. 20, 2011
(86) PCT No.: PCT/DE2011/001313

§ 371 Date: Dec. 14, 2012

(30) Foreign Application Priority Data
Jul. 21, 2010 (DE) 10 2010 031 816.7

(51) Int. Cl. F21V 31/00; F21L 4/00

(52) U.S. Cl. CPC F21V 31/005; F21L 4/00
USPC 362/158

(57) ABSTRACT

The present invention relates to a flashlight having a housing, a battery cartridge which is mounted therein and has a pressure switch at the end, and an end cap having a pushbutton which is operatively connected to the pressure switch. In order to create a watertight and simultaneously robust flashlight, it is proposed according to the invention that a sealing element be arranged between the pushbutton and the pressure switch.

The present invention relates to a flashlight having a housing, a battery cartridge which is mounted therein and has a pressure switch at the end, and an end cap having a pushbutton which is operatively connected to the pressure switch.

Flashlights of the type mentioned at the beginning are known from the prior art. For example, DE 10 1007 032 003 describes such a flashlight, which is disadvantageously not formed in a watertight manner.

DE 24 13 016 [U.S. Pat. No. 3,798,440] discloses a watertight flashlight, which has a pressure switch arranged in the housing. The pressure switch has a rubber switch cover, wherein an additional sealing ring is arranged between the switch cover and the housing. In order to actuate the pressure switch, the elastic switch cover has to be pushed merely downward.

Watertight flashlights are frequently used outdoors, where the requirements for a robust configuration of the flashlight are high, since the material is highly stressed not only while the flashlight is being used as intended, but also while it is being transported in backpacks or in panniers. In this case, in particular the housing is exposed to high loads, and so the soft and low-resistance switch cover also wears out relatively quickly and has to be replaced.

It is therefore the object of the present invention to remedy this and to propose a watertight and simultaneously robust flashlight.

This object is achieved by the flashlight according to claim 1, wherein, according to the invention, a sealing element is arranged between the pushbutton and the pressure switch. As a result, the complete housing, including the pushbutton, consists of a robust material, which is formed preferably in a scratch- and impact-resistant manner. According to one embodiment of the invention, the housing consists of an optionally coated light metal, such as aluminum, for example, or a plastics material. Nevertheless, the flashlight according to the invention is formed in a watertight manner, with the sealing element being arranged such that it cannot be damaged by other objects and accordingly has to be replaced comparatively rarely.

Preferred embodiments of the present invention are specified in the following text and in the dependent claims.

According to a first configuration, the pushbutton has a head part protruding out of the end cap, a guide part mounted in the end cap and an actuating part. The guide part is formed such that the pushbutton is longitudinally axially movable within the end cap, with a rear stop surface preventing the pushbutton from falling out of the end cap. The actuating part is formed in a preferably cylindrical manner and connected indirectly to the pressure switch, with the sealing element being arranged between the actuating part and the pressure switch. The sealing element is preferably a cap made of an elastic material, with the cap having an annular clamping surface and an elevation protruding therefrom. Suitable materials for the sealing element are in particular rubber or some other elastomer, such as polyurethane or PVC, for example. In the assembled state, the pressure switch is arranged beneath the elevation of the cap, so that the pressure switch can be actuated indirectly by the pushbutton.

According to a preferred embodiment, it is provided that in the elevation of the cap there is formed a blind-hole-like depression into which the actuating part engages. As a result, the sealing element is connected at least so firmly to the pushbutton or the end cap that the sealing element cannot fall off and be lost, if the end cap is removed from the housing for example in order to change the batteries. Alternatively thereto, the sealing element can also be clamped captively in an annular groove within the end cap. In this case, it is preferably provided that the end cap has an internal thread and an external thread, so that the end cap is connected both to the battery cartridge and to the housing via corresponding threaded portions. A threaded connection can be produced easily and additionally represents a robust connection. Furthermore, the watertight connection can be created via a threaded connection, since the sealing element is preferably clamped by way of the annular clamping surface between two annular stop surfaces of the end cap and the battery cartridge. The more firmly the threaded connection is closed, the tighter the connection.

Further preferred configurations and specific embodiments are explained in the following text with reference to the drawings, in which:

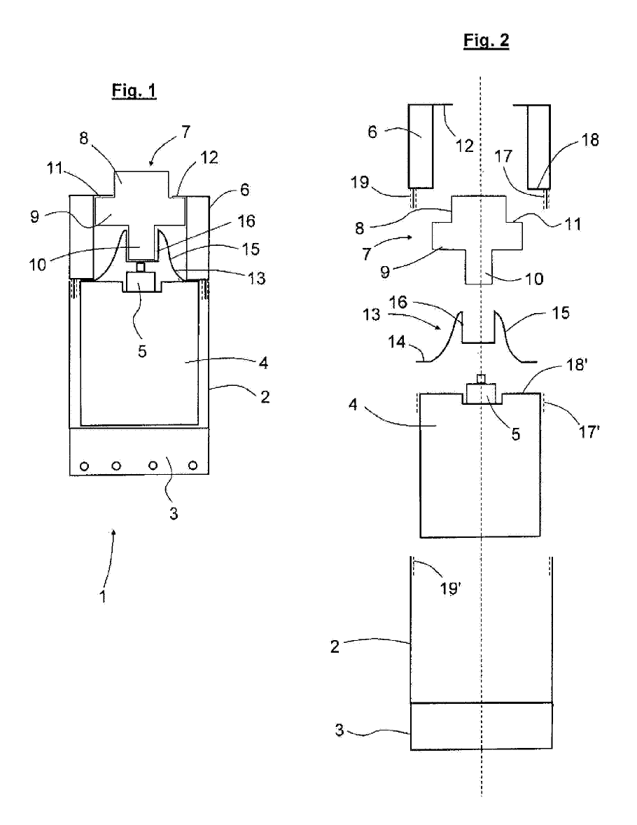

FIG. 1 shows a cross-sectional view of a flashlight in the assembled state, and

FIG. 2 shows an exploded illustration of a flashlight.

The flashlight 1 consists substantially of a housing 2 having a lamp head 3, a battery cartridge 4 having a pressure switch 5 arranged at the end, and an end cap 6 having a pushbutton 7 that is axially longitudinally movable therein. The pushbutton has a head part 8, a guide part 9 and an actuating part 10. In order that the pushbutton 7 cannot fall out of the end cap 6 in the assembled state, an annular stop surface 11 is formed on the guide part 9, the stop surface 11 being in abutment with a likewise annular stop surface 12 within the end cap 6. In order to protect the interior of the housing 2 from penetrating water, a sealing element 13 is arranged between the pushbutton 7 and the pressure switch 5. The sealing element 13 is preferably formed in a rotationally symmetrical manner and has an annular clamping surface 14 and an elevation 15, in which there is formed a blind-hole-like depression 16. The actuating part 10 engages in the depression 16. In order to connect the battery cartridge to the end cap, there are arranged corresponding threaded portions 17, 17′. Furthermore, annular stop surfaces 18, 18′ are arranged on the battery cartridge 4 and on the end cap 6, it being possible to clamp the sealing element 13 firmly between the annular stop surfaces 18, 18′ by way of the annular clamping surface 14. Finally, corresponding threaded portions 19, 19′ are formed on the end cap 6 and on the housing 2. In order to form the flashlight in a watertight manner overall, this threaded connection can also be sealed off by way of a seal (not illustrated).

1. A flashlight having a housing, a battery cartridge which is mounted therein and has a pressure switch at the end, and an end cap having a pushbutton which is operatively connected to the pressure switch,
wherein
a sealing element is arranged between the pushbutton and the pressure switch.

2. The flashlight as claimed in claim 1, wherein the pushbutton has a head part protruding out of the end cap, a guide part mounted in the end cap and an actuating part.

3. The flashlight as claimed in claim 1, wherein the sealing element is a cap made of elastomeric material, wherein the cap has an annular clamping surface and an elevation protruding therefrom.

4. The flashlight as claimed in one of claims 1, wherein in the elevation of the cap there is formed a blind-hole-like depression into which the actuating part engages.

5. The flashlight as claimed in one of claims 1, wherein the end cap has an internal thread and an external thread, so that the end cap is connected both to the battery cartridge and to the housing via corresponding threaded portions.

6. The flashlight as claimed in one of claims 1, wherein the sealing element is clamped by way of the annular clamping surface between two annular stop surfaces of the end cap and the battery cartridge.

7. A flashlight comprising:
a housing having rear end;
a removable end cap on the rear end of the housing;
a light source on the housing;
a battery cartridge in the housing carrying a switch actuatable to connect a battery in the cartridge to the light source;
a pushbutton shiftable on the end cap; and
a seal membrane secured to the housing, extending between the pushbutton and the switch, and sealing the battery off from the rear end of the housing such that water entering around the pushbutton cannot get to the battery cartridge.

8. The flashlight defined in claim 7, wherein the membrane is flexible and has a circular outer periphery lying in a plane and clamped between the end cap and the housing.

9. The flashlight defined in claim 8, wherein the housing is centered on an axis and the membrane has a center part offset axially rearward from the outer periphery and engaged axially between the pushbutton and the switch.

10. The flashlight defined in claim 9, wherein the pushbutton has an axially forwardly extending projection and the membrane has an axially rearwardly open cup-shaped seat complementarily receiving the projection.

11. The flashlight defined in claim 10, wherein the projection and seat are both of cylindrical shape and centered on the axis.
